(19) United States
(12) Patent Application Publication
(10) Pub. No.: US 2023/0311115 A1
(43) Pub. Date: Oct. 5, 2023

(54) METHOD FOR MANUFACTURING MICROCHIP FOR LIQUID SAMPLE ANALYSIS

(71) Applicant: FUJIMORI KOGYO CO., LTD., Tokyo (JP)

(72) Inventors: Masato ABE, Tokyo (JP); Tomoko WADA, Tokyo (JP); Takao SATO, Tokyo (JP); Kazuya HOSOKAWA, Tokyo (JP)

(21) Appl. No.: 18/043,311

(22) PCT Filed: Aug. 31, 2021
(86) PCT No.: PCT/JP2021/031943

§ 371 Date: Feb. 27, 2023

(30) Foreign Application Priority Data
Aug. 31, 2020 (JP) 2020-146111

(51) Int. Cl. B01L 3/00

(52) U.S. Cl. CPC B01L 3/502707

(57) ABSTRACT

A method for manufacturing a microchip for analyzing a component in a liquid sample by passing the sample through a flow path provided inside and performing a reaction in a reaction portion provided in a portion of the flow path, the method including: a step of providing a substrate including on the surface thereof a groove serving as a flow path and a reaction portion in a portion between the both ends of the groove; a step of applying an adhesive agent or a gluing agent on an area other than the groove on the grooved surface of the substrate; a step of providing a film on an area of which a reaction substance is applied; and a step of attaching the film on the substrate in a specific manner.

### TECHNICAL FIELD

The present invention relates to a method for manufacturing a microchip for analyzing a liquid sample.

### BACKGROUND OF THE INVENTION

It is known that a liquid sample such as blood is introduced into a flow path in a microchip and reacted with an antibody or the like in a reaction portion provided in the middle of the flow path to analyze a component in the liquid sample.

For preparation of such a microchip, a method of bonding a substrate on whose surface a groove serving as a flow path is formed with a film using an adhesive agent is known (Patent Literature 1 or 2).

However, a conventional method employs beads immobilized with antibodies or the like to be used for a reaction and arranged in a reaction portion in a flow path, and since manufacturing a microchip is costly and time-consuming, a more convenient preparation method has been desired.

### PRIOR ART DOCUMENTS

### Patent Documents

Patent Document 1 JP2008-232939 A

Patent Document 2 JP 2008-175795 A

### SUMMARY OF INVENTION

### Problems to be Solved by the Invention

An object of the present invention is to provide a simple and inexpensive method for manufacturing a microchip for analyzing a component in a liquid sample by passing the liquid sample through a flow path provided inside and performing a reaction in a reaction portion provided in a portion of the flow path.

Solution to Problem

In order to solve the above-described problem, the present inventors carried out an intensive study. As a result, it was found that a microchip can be easily manufactured by preparing a substrate including on the surface thereof a groove serving as a flow path and a reaction portion in a portion between the both ends of the groove, and applying at least one of an adhesive agent and a gluing agent on an area other than the groove on the grooved surface of the substrate, while preparing a film on some areas of which a reaction substance is applied, and attaching the film on the substrate in such a manner that the groove on the substrate is covered by the film to form the flow path, and that the reaction portion of the applied surface of at least one of the adhesive agent and the gluing agent on the substrate overlaps the area of the film on which the reaction substance is applied, and found that the obtained microchip can be suitably used for analyzing a component in a liquid sample without leakage of liquid. Furthermore, the present inventors found conditions such as the type of adhesive agent and gluing agent for efficiently attaching a substrate and a film together, thereby completing the present invention.

In other words, the present invention provides a method for manufacturing a microchip for analyzing a component in a liquid sample by passing the sample through a flow path provided inside and performing a reaction in a reaction portion provided in a portion of the flow path, the method including:
a step of providing a substrate including on the surface thereof a groove serving as a flow path and a reaction portion in a portion between the both ends of the groove, and applying at least one of an adhesive agent and a gluing agent on an area other than the groove on the grooved surface of the substrate;
a step of providing a film on an area of which a reaction substance is applied; and
a step of attaching the film on the substrate in such a manner that the groove on the substrate is covered by the film to form the flow path, and that the reaction portion of the adhesive agent- and/or the gluing agent-applied surface of the substrate overlaps the area of the film on which the reaction substance is applied.

Here, it is preferable that the substrate is made of any one of plastic, silicone, or glass.

It is preferable that the film is a film of cyclo-olefin polymer (COP), cyclo-olefin copolymer (COC), polymethyl methacrylate (PMMA), polystyrene (PS), polycarbonate (PC), or polyethylene terephthalate (PET).

It is preferable that the reaction substance is an antibody, an enzyme, a nucleic acid, or a bead containing them.

It is preferable that the adhesive agent and the gluing agent are UV curing.

It is preferable that the application method of the adhesive agent and the gluing agent to an area of the substrate other than the groove is by screen printing.

The surface of the substrate may be hydrophilized, and at least one of the adhesive agent and the gluing agent may be applied to the hydrophilized surface.

In one aspect of the present invention, the substrate or the film may be provided with through holes serving as an inlet and an outlet at positions corresponding to both ends of the reaction portion of the flow path formed by attaching the substrate and the film together.

In one aspect of the present invention, the substrate on the surface of which at least one of the adhesive agent and the gluing agent is applied may be attached to the film after a stirrer is arranged in a depression serving as the reaction portion.

In one aspect of the present invention, a mixture of an adhesive agent and a gluing agent may be applied to an area of the substrate other than the groove.

In one aspect of the present invention, the adhesive agent is applied to an inner side area excluding the outer circumference portion of the substrate, other than the groove serving as the flow path and the gluing agent is applied to an area of the film corresponding to the outer circumference portion of the substrate when attached together, and both the areas may be attached together with the surface to which the adhesive agent or the gluing agent is applied inside.

In one aspect of the present invention, an area of the film to which the reaction substance is applied may be hydrophilized, and the reaction substance may be applied over the hydrophilized area. The film may be attached to a substrate in which at least a portion of the groove is hydrophilized

### Effects of Invention

According to the present invention, a microchip for analyzing a component in a liquid sample can be manufactured easily and inexpensively.

### BRIEF DESCRIPTION OF DRAWINGS

FIGS. 1A to 1D are one aspect of the microchip of the present invention. FIG. 1A illustrates a substrate of the microchip (before application of an adhesive agent), FIG. 1B illustrates a substrate of the microchip (after application of an adhesive agent), FIG. 1C illustrates a film of the microchip, and FIG. 1D illustrates a view of the completed microchip.

FIGS. 2A to 2D are one aspect of the microchip of Example 6. FIG. 2A illustrates a substrate of the microchip (before application of an adhesive agent), FIG. 2B illustrates a substrate of the microchip (after application of an adhesive agent), FIG. 2C illustrates a film of the microchip, and FIG. 2D illustrates a view of the completed microchip.

FIGS. 3A to 3D are one aspect of the microchip of Example 1. FIG. 3A illustrates a substrate of the microchip (before application of an adhesive agent), FIG. 3B illustrates a substrate of the microchip (after application of an adhesive agent), FIG. 3C illustrates a film of the microchip, and FIG. 3D illustrates a view of the completed microchip.

FIGS. 4A to 4D are one aspect of the microchip of Example 5. FIG. 4A illustrates a substrate of the microchip (before application of an adhesive agent), FIG. 4B illustrates a substrate of the microchip (after application of an adhesive agent), FIG. 4C illustrates a film of the microchip (after application of a gluing agent), and FIG. 4D illustrates a view of the completed microchip.

### DESCRIPTION OF EMBODIMENTS

The manufacturing method of the present invention is a method for manufacturing a microchip for analyzing a component in a liquid sample by passing the sample through a flow path provided inside and performing a reaction in a reaction portion provided in a portion of the flow path.

A liquid sample is not particularly restricted as long as the sample can pass through the microchip, and examples thereof include a liquid sample obtained from a living body, such as blood or urine, or a diluted liquid thereof, an extract from a living body, such as a plant or animal, naturally occurring water, such as river, ocean, or rainfall, washing liquid, and waste liquid. A component in a sample is also not particularly restricted, and examples thereof include a protein, a nucleic acid, a low molecular weight compound, and a sugar.

The manufacturing method of the present invention includes:
a step of providing a substrate including on the surface thereof a groove serving as a flow path and a reaction portion in a portion between the both ends of the groove, and applying at least one of an adhesive agent and a gluing agent on an area other than the groove on the grooved surface of the substrate;
a step of providing a film on an area of which a reaction substance is applied; and
a step of attaching the film on the substrate in such a manner that the groove on the substrate is covered by the film to form the flow path, and that the reaction portion of the adhesive agent- and/or the gluing agent-applied surface of the substrate overlaps the area of the film on which the reaction substance is applied.

In the manufacturing method of the present invention, instead of a film, a second substrate on the surface of which no grooves serving as flow paths are formed may be used. In such a case, the description of a film described below can be applied to a second substrate as it is.

Hereinafter, the manufacturing method of a microchip for analyzing a liquid sample of the present invention will be described with reference to the drawings. However, the following is only an example, and the manufacturing method of the present invention and a microchip obtained by the method are not limited to the following aspects.

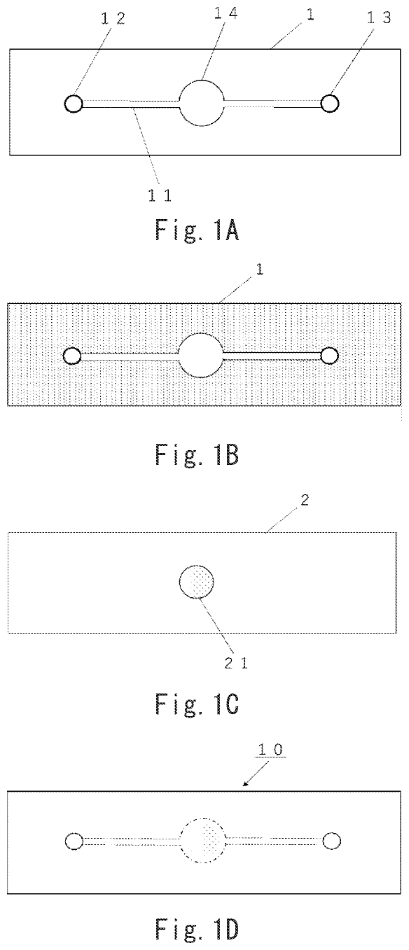

FIGS. 1A to 1D are conceptual diagrams illustrating an example of a form of a microchip 10.

FIG. 1A is a plan view of a substrate 1 on the surface of which a groove serving as a flow path 11 of the microchip 10 is carved. On a first end side of a groove, a through hole serving as an inlet 12 for a liquid sample is provided, and on the other end side, a through hole serving as an outlet 13 is provided. In the middle of a groove, specifically, a portion between a through hole serving as the inlet 12 and a through hole serving as the outlet (discharge port) 13 is provided with a depression serving as a reaction portion 14.

Two or more flow paths may be provided. The shape of a flow path may be any shape, and may be straight or curved. A flow path may include a branch. In such a case, a flow path may include two or more inlets, reaction portions, and/or air holes. For example, two inlets may be provided, a liquid sample may flow from the first inlet to the first flow path and a reaction matrix liquid from the second inlet to the second flow path, and a reaction portion may be provided at a confluence of the first flow path and the second flow path, and a confluence flow path and an outlet (discharge port) may be provided downstream of the reaction portion.

An inlet and an outlet may be provided on either side of the substrate or the film. For example, a groove serving as a flow path may be provided on a substrate, and a film provided with holes at positions overlapping the two end sides of the groove may be prepared and attached to the substrate. One of holes serving as an inlet and an outlet may be provided on a substrate, and the other may be provided on a film.

The cross-sectional shape of a groove serving as a flow path may be any shape, such as concave, U-shaped, or V-shaped. The depth of a groove serving as a flow path is preferably from 10 to 500 μm, and the width of the groove is preferably from 10 μm to 3 mm. The length of a portion corresponding to the flow path is, for example, from 3 mm to 5 cm.

The width of a groove may be constant or may vary. The depth of a groove may also be constant, but may vary.

A depression serving as a reaction portion may be of any size as long as the depression is large enough to store a liquid sample introduced through an inlet and to react with a reaction substance contained in the reaction portion, and the shape of the depression is also not restricted. For example, the depression may be cylindrical or prismatic, and by increasing the area and depth, a larger amount of liquid sample can be stored. The area of a depression is, for example, from 0.1 to 50 mm², and in the case of a circular reaction portion, the diameter is, for example, from 0.2 to 6 mm. However, the area may vary with the depth of the groove, and the shape of the depression may be, for example, mortar-shaped. The depth of a depression is preferably deeper than the depth of the groove serving as the flow path, and is, for example, from 20 μm to 3 mm.

In cases where a reaction portion extends, for example, in a cylindrical or prismatic shape with respect to a flow path, air may easily be stored in the reaction portion. In such cases, hydrophilizing all or part of a film and/or a substrate (such as a groove serving as a flow path in the substrate or a portion of the film covering the flow path) can control the direction of flow and prevent air bubbles from remaining in the cylindrical or prismatic reaction portion. A hydrophilization treatment may be performed on a portion of a substrate corresponding to a reaction portion and on a portion of a film covering the reaction portion.

In cases where a reaction between a reaction substance and a sample proceeds quickly, or in cases where the velocity of a sample in a reaction portion is very slow, or where the movement of a sample pauses or reciprocates in a reaction portion, the reaction portion may have the same depth as a flow path, since there is no need to store a liquid sample in the reaction portion. In other words, there is no need to provide a depression, and only the width of a flow path may be increased without providing a depression. A reaction portion may be the same width as a flow path.

Widening the width of a flow path and providing a depression is suitable for mixing a sample and a reaction substance with a stirrer to accelerate a reaction. On the other hand, widening the width of a flow path without changing the depth is suitable for dissolving and diffusing a reaction substance without agitation by increasing the contact area with the reaction substance, and the width can be selected according to the purpose of a test.

On the downstream side of a flow path, a wider portion serving as a waste liquid (solution) reservoir may be provided. In other words, one aspect of the present invention is shaped such that a waste liquid reservoir is connected to a different end of the flow path 11 than the end on the inlet side. This allows a liquid sample that has passed through a flow path to remain in the waste liquid reservoir. A solution reservoir may be provided on the upstream side of the flow path.

A through hole (either on the substrate side or on the film side) can be provided in a portion of the waste liquid reservoir to act as an air hole.

In a waste liquid reservoir, an absorbent material of a size that can be accommodated in the waste liquid reservoir can also be installed. Examples of the absorbent material include a sponge and a cloth. The depth of a groove corresponding to a waste liquid reservoir is preferably deeper than the depth of a groove corresponding to a flow path in order to store more waste liquid.

The size of a through hole serving as the inlet 12 may be any size that allows injection of a liquid sample such as blood using a microsyringe or the like. For example, the diameter is from 0.2 to 3 mm.

The size of a through hole serving as the outlet 13 is not particularly restricted, as long as the through hole is large enough to function as an outlet for a liquid sample, and for example, the diameter is from 0.2 to 2 mm.

The material of a microchip can be metal, glass, plastic, silicone, or the like, and from the viewpoint of detecting a reaction by luminescence, coloration, or visual inspection, a transparent material is preferable, and a transparent plastic is more preferable. Examples thereof include polyethylene, polypropylene, polystyrene, polymethyl methacrylate, cyclo-olefin polymer, cyclo-olefin copolymer, polyphenylene oxide, polyethylene terephthalate, polyethylene naphthalate, polycarbonate, polyamide, polyimide, a phenol resin, an epoxy resin, a polyvinylidene chloride, a polyvinyl chloride, an ABS resin, and a poly(2-methoxyethyl acrylate) (PMEA) resin.

A groove or a hole provided in a substrate of a microchip can be engraved with a blade or a laser beam, and when the material of the microchip is plastic, such a groove or a hole can also be formed by injection molding. Formation by injection molding is preferable since microchips of consistent quality can be produced efficiently.

The hydrophilization treatment is preferably performed by applying a hydrophilic reagent or a plasma treatment. Examples of the hydrophilic reagent include a nonionic surfactant such as S-1570 (sucrose fatty acid esters: MITSUBISHI-CHEMICAL FOODS CORPORATION), LWA-1570 (sucrose laurate: MITSUBISHI-CHEMICAL FOODS CORPORATION), POEM DL-100 (diglycerin monolaurate: RIKEN VITAMIN Co., Ltd.), or RIKEMAL A (sucrose fatty acid esters: RIKEN VITAMIN Co., Ltd.), CeraAqua NS235-N1 (SHIMA TRADING CO., LTD.), Aminoion (NIPPON NYUKAZAI CO., LTD.), LAMBIC-771W (OSAKA ORGANIC CHEMICAL INDUSTRY LTD.), LAMBIC-1000W (OSAKA ORGANIC CHEMICAL INDUSTRY LTD.), SPRA-101 (Tokyo Ohka Kogyo Co., Ltd.), and SPRA-202 (TOKYO OHKA KOGYO CO., LTD.). Examples of specific conditions include a condition where the water contact angle of a substrate surface is, for example, 55° or less.

FIG. 1C is a plan view of Film 2. The material of a film is preferably a transparent plastic, and the materials described above are exemplified, and a PET resin, a COP resin, a COC resin, a PS resin, a PC resin, or a PMMA resin is more preferable.

The thickness of a film is, for example, preferably from 50 to 200 μm, and more preferably from 100 to 200 μm.

A film is coated with a reaction substance in an area overlapping the reaction portion 14 on the flow path 11 when layered with the substrate 1, and when this coated area 21 is layered with the substrate 1, the reaction portion accommodates the reaction substance.

The reactive substance can be any substance that reacts with a target (detection target) component in a liquid sample, and can be appropriately selected according to the type of a target substance. Examples of the reactivity of a reactive substance include a biological reaction and a chemical reaction, and examples of the biological reaction include a binding reaction. Examples of the reactive substance include a protein (including a peptide), a sugar, a nucleic acid, and a low molecular weight compound. Examples thereof include a substance such as an antibody that binds specifically to a target substance, an enzyme protein that uses a target substance as a matrix, and a blood coagulation factor such as a PT reagent. When the target substance is a nucleic acid, a nucleic acid probe or a polymerase (nucleic acid amplifying enzyme) that amplifies a nucleic acid may be used.

Two or more reactive substances may be used, and two or more reactive substances may be coated on a film. A substance other than a reactive substance may also be coated on a film together. For example, when the reactive substance is an enzyme, a matrix for the enzyme or a buffer agent may also be coated together.

Such a matrix, a buffer, or the like may be accommodated in a depression or the like serving as a reaction portion on the substrate side. When two types of reactive substances are used, one type may be coated on a film and the other type may be accommodated in a depression or the like serving as a reaction portion on the substrate side. By coating reaction substances separately on a substrate reaction portion and on a film, it is possible to prevent aggregation or reaction during manufacturing of a microchip by coating reagents that would react or aggregate when mixed, or two reagents that would react, such as an enzyme and a matrix, on the substrate and on the film, and attaching them together in such a manner that they overlap.

As a reaction substance, an enzyme or an antibody may be immobilized on a microbead and then coated on a film. By immobilizing a reaction substance on a microbead and then coating the microbead, the contact area between a liquid sample and a reaction substance is increased, and a reaction can be accelerated.

The amount of a reactive substance coated can be appropriately set depending on the type of the reactive substance, and the amount is, for example, from 1 to 10,000 μg/cm². A plurality of reactive substances may be coated.

Coating of a reaction substance can be appropriately selected depending on the type of the reaction substance, and known methods can be employed, and examples thereof include preparing a solution of the reaction substance, spotting the solution at a predetermined position on a film, and drying the film naturally or under reduced pressure.

When a plastic is used as a film material, an aqueous solution of a reaction substance can be precisely applied to an area on a film where the reaction substance is to be coated by precisely applying a hydrophilic reagent by inkjet printing or dispensing, performing a hydrophilization treatment, and dropping an aqueous solution of the reaction substance on a desired hydrophilized area by a pipette, a syringe, or the like. The aqueous solution of the reaction substance is spread uniformly over the pre-hydrophilized area on the film. The applied aqueous solution of the reaction substance is preferably naturally dried or dried or freeze-dried under reduced pressure, thereby coating the reaction substance.

The hydrophilization treatment on a film for precise application of an aqueous solution of a reaction substance is not particularly restricted, and the contact angle is preferably 55° or less, and preferably 40° or less. When the contact angle is 55° or less, a dropped aqueous solution of the reaction substance favorably spreads over the pre-hydrophilized area.

Alternatively, a reactive functional group can be introduced onto a target area of the surface of a film and reacted with a functional group of a reactive substance to achieve stable immobilization by covalent bonding.

FIG. 1D is a plan view of the microchip 10 obtained by attaching the substrate 1 and the film 2 together in such a manner that the grooved surface of the substrate 1 and the surface applied with a reactive substance of the film 2 are in contact with each other. The dashed lines indicate that the flow path 11, the reaction portion 14, and the like are inside the microchip 10.

By layering the film 2 on the substrate 1 and attaching them together, the film covers the tops of a groove and a depression serving as a flow path and a reaction portion, forming a flow path through which a liquid sample passes and a reaction portion in which a reaction takes place.

By layering the film, one side of a through hole is sealed, and only the side of the substrate that is not layered with the film is an opening. This allows the opening to function as an inlet or an outlet.

In other words, a liquid sample introduced from an inlet reacts with a reaction substance in a reaction portion, and is then discharged from an outlet. By observing or detecting a reaction in a reaction portion, a target substance in a sample can be measured. Examples of the reaction include, but are not limited to, a chromogenic reaction, a luminescence reaction, an amplification reaction, and an aggregation reaction.

In order to attach the film 2 onto the substrate 1, an adhesive agent and/or a gluing agent are used.

Examples of the adhesive agent include a (meth)acrylic resin-based adhesive, a natural rubber adhesive, a urethane resin-based adhesive, an ethylene-vinyl acetate resin emulsion adhesive, an ethylene-vinyl acetate resin-based adhesive, an epoxy resin-based adhesive, a vinyl chloride resin solvent-based adhesive, a chloroprene rubber-based adhesive, a cyanoacrylate-based adhesive, a silicone-based adhesive, a styrene-butadiene rubber solvent-based adhesive, a nitrile rubber-based adhesive, a nitrocellulose-based adhesive, a phenolic resin-based adhesive, a modified silicone-based adhesive, a polyester-based adhesive, a polyamide-based adhesive, a polyimide-based adhesive, an olefin resin-based adhesive, a polyvinyl acetate resin emulsion-based adhesive, a polystyrene resin solvent-based adhesive, a polyvinyl alcohol-based adhesive, a polyvinyl pyrrolidone resin-based adhesive, a polyvinyl butyral-based adhesive, a polybenzimidazole adhesive, a polymethacrylate resin solvent-based adhesive, a melamine resin-based adhesive, a urea resin-based adhesive, and a resorcinol-based adhesive. One or more adhesive agents can be used singly, or two or more kinds thereof can be used in mixture.

Examples of the gluing agent include a rubber-based adhesive, a (meth)acrylic adhesive, a silicone-based adhesive, a urethane-based adhesive, a vinyl alkyl ether-based adhesive, a polyvinyl alcohol-based adhesive, a polyvinyl pyrrolidone-based adhesive, a polyacrylamide-based adhesive, and a cellulose-based adhesive. Such gluing agents may be used singly, or two or more kinds thereof may be used in mixture.

The adhesive agent or gluing agent is preferably light-curing (either radical reactive or cationic polymerization), and more preferably UV-curing. With a UV curing adhesive agent or gluing agent, after an application process, irradiation with UV light quickly initiates a curing reaction, allowing bonding to take place. For the UV curing adhesive agent, for example, an acrylic UV curing adhesive agent such as UVX-8204 (manufactured by Denka Company Limited.), UVX-8400 (manufactured by Denka Company Limited.), SX-UV100A (manufactured by CEMEDINE CO., LTD.), SX-UV200 (manufactured by CEMEDINE CO., LTD.), BBX-UV300 (manufactured by CEMEDINE CO., LTD.), U-1340 (Chemitech Inc.), U-1455B (Chemitech Inc.), U-1558B (Chemitech Inc.), Aronix UV-3000 (TOAGOSEI CO., LTD.), TB3094 (ThreeBond Co., Ltd.), or Hitaroid 7975D (Hitachi Chemical Company, Ltd.) is more preferable. For the UV curing gluing agent, an acrylic UV curing gluing agent such as UV-3630ID80 (Mitsubishi Chemical Corporation), UX-3204 (Nippon Kayaku Co., Ltd.), or FINETAC RX-104 (DIC Corporation) is more preferable. An acrylic UV curing adhesive agent and gluing agent can exhibit favorable adhesion to a wide range of plastic materials and achieve rapid strength development after UV irradiation. The viscosity of an adhesive agent and a gluing agent used for attaching the film 2 onto the substrate 1 is preferably, for example, from 2,000 to 31,000 mPa·s.

An adhesive agent and a gluing agent are applied to an area of a substrate surface other than a groove. For example, as illustrated in FIG. 1B, an adhesive agent and a gluing agent are preferably applied to an area of a substrate surface excluding a flow path and a reaction portion. For more accurate application to an area other than a groove, an adhesive agent and a gluing agent are preferably applied by a printing technique, and particularly preferably by screen printing. By using screen printing, even when a plate covering the entire surface of a substrate is filled with an adhesive agent and a gluing agent, the adhesive agent and the gluing agent are transferred to an area other than a groove that is in contact with a screen printing plate, but not to a groove that is not in contact with the plate. Therefore, the adhesive agent and the gluing agent can be favorably applied to an area other than a groove.

The film thickness of the applied adhesive agent and gluing agent is preferably from 5 to 15 μm. For controlling the film thickness of an adhesive agent and a gluing agent, the mesh count per inch of screen is preferably, for example, from 500 to 730. The opening ratio of the mesh is preferably, for example, from 39 to 47%. The thickness of a mesh is preferably, for example, from 15 to 28 μm. With this, the film thickness of the applied adhesive agent and gluing agent is preferably from 5 to 15 μm.

As other methods of applying an adhesive agent and gluing agent to a substrate, inkjet printing, gravure printing, or a dispenser can be used to precisely apply an adhesive agent to the outside of a flow path.

In these application techniques, when an adhesive agent and a gluing agent are discharged against a groove, the adhesive agent is applied inside the groove and changes the shape of the flow path. Therefore, an adhesive agent and a gluing agent need to be applied to an area other than a groove by capturing an image of the groove position of a substrate, or by programming the printing or dispensing system to apply the adhesive agent and the gluing agent to an area other than a groove after fixing the position of a printing stage and the substrate.

After hydrophilizing the surface of a substrate, an adhesive agent and a gluing agent may be applied. A plasma treatment or a corona treatment is preferable as the hydrophilization treatment.

By using conditions where a substrate does not repel an adhesive agent or a gluing agent, and where the adhesive agent and the gluing agent spread on the substrate and do not flow into a flow path, a favorable attachment can be achieved.

Furthermore, in order to improve the internal pressure strength and peel strength of a microchip and to reduce elution into a flow path, a microchip can be manufactured by applying an adhesive agent to the inner area of a substrate surface (area other than a groove), excluding the outer circumference portion (for example, an area of from 1 to 5 mm in width at the outer circumference portion), while applying a gluing agent to the outer circumference portion (for example, an area of from 1 to 5 mm in width at the outer circumference portion) of a film serving as a bonding partner to a substrate with a groove molded therein, and bonding these areas together.

For the inner side area of a substrate surface, including an area around a groove, a UV curing adhesive agent, in particular, a radical reactive acrylic UV curing adhesive agent is preferably selected. A radical reactive acrylic UV curing adhesive agent can be completely cured by UV irradiation in a nitrogen-filled environment to suppress inhibition of curing by oxygen. This can improve the internal pressure strength inside a flow path. Furthermore, by allowing the adhesive agent to cure completely and completing the polymerization reaction of a polymer contained in the adhesive agent, elution of components derived from the adhesive agent into the flow path can be reduced. Although the method of creating a nitrogen-filled environment is not particularly restricted, a nitrogen displacement box composed of members made of a UV-transparent material such as an intake valve, an exhaust valve, a relief valve, or glass is preferable since UV irradiation in a nitrogen atmosphere can be realized in a simplified manner.

For the outer circumference portion, a UV curing gluing agent can be selected. A UV curing gluing agent can provide peel strength to a microchip without causing easy peeling even when subjected to physical external stress, and even when peeling occurs, the film can be adhered again by finger pressure or the like.

Even in cases where an adhesive agent is applied to the inner area of a substrate surface, including an area around a groove, and a gluing agent is applied to the outer circumference portion of the substrate, the adhesive agent can be precisely applied to the area other than the groove by screen printing.

The method of applying a gluing agent is not particularly restricted. After a step of applying an adhesive agent and a gluing agent, each application area is positioned without overlapping, attached together, then UV-irradiated to achieve efficient production.

After applying an adhesive agent and a gluing agent to the surface of a substrate, a stirrer can be placed in a depression serving as a reaction portion, after which the substrate and a film can be attached together. This allows a stirrer to be accommodated in a reaction portion, and a reaction between a reactive substance and a target substance in a liquid sample can be efficiently progressed by driving the stirrer with an externally applied magnetic force or the like. The stirrer may be hydrophilized This can suppress accumulation of air bubbles around the stirrer.

Hereinafter, the present invention will be specifically described with reference to Examples, but the present invention is not limited to the following aspects.

### Example 1

### <Microchip Preparation 1>

The presence or absence of a solvent and the curing mode of an adhesive agent or a gluing agent to be applied to a microchip were examined

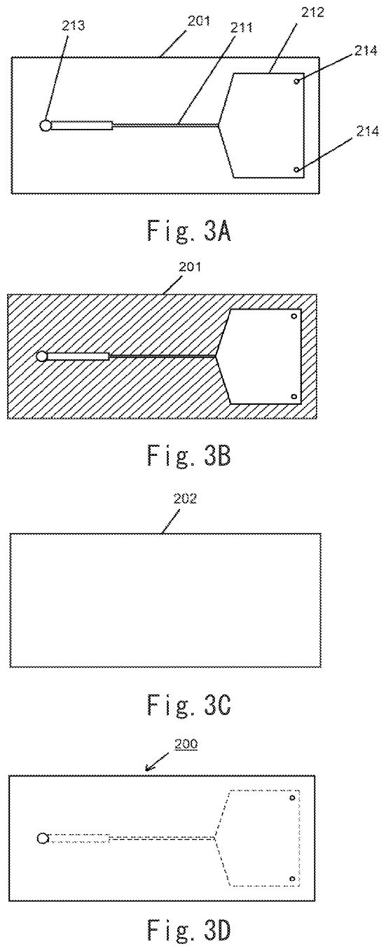

A substrate 201 (injection molded product manufactured by MCC Advanced Moldings Co., Ltd.: COP resin) (size 59.4×26.2 mm, thickness 3.0 mm) illustrated in FIG. 3A was prepared. In the substrate 201, a flow path 211 had a length of 33.6 mm, a depth of 80 μm, a width of 1.2 mm at an inlet and 0.3 mm at a narrowing portion, and a waste liquid reservoir 212 had a length of 16.5 mm, a depth of 2.2 mm, and a width of 20.2 mm. In the substrate 201, a hole serving as an inlet 213 was a through hole with a circular cross sectional shape with an inner diameter of 2 mm. On the other hand, a hole serving as an air hole 214 was a through hole with a circular cross sectional shape with an inner diameter of 1 mm.

For a film of FIG. 3C, a COP film (size 70×50 mm, thickness 100 μm) was used.

For attaching the substrate 201 and the film 202 together, UVX-8204, a solvent-free, radical reactive acrylic UV curing adhesive agent, or a radical reactive acrylic UV curing gluing agent containing ethyl acetate as a diluent, was used. As illustrated in FIG. 3B, an adhesive agent or a gluing agent was applied to the surface of the substrate 201 provided with a flow path and a solution reservoir by the following method. The adhesive agent or the gluing agent was applied to the surface of the substrate 201 provided with a flow path and a solution reservoir by screen printing. In a screen plate used, the mesh count was 640 and the opening ratio was 39%.

The application thickness of the adhesive agent or the gluing agent was about 7 μm.

The adhesive agent or gluing agent applied surface of the substrate 201 was layered with the film 202 and irradiated with Ultraviolet light of 365 nm wavelength for from 10 to 20 seconds using a UV-LED light source to initiate a curing reaction of the adhesive agent and bond the film 202 on the substrate 201 (FIG. 3D).

### <Microchip Evaluation 1>

As a result of preparing a microchip 200, when an acrylic UV curing gluing agent containing ethyl acetate as a diluent was used, volatilization of the solvent progressed on the screen plate, and the viscosity of the gluing agent gradually increased. As a result, about 5 minutes after the gluing agent was arranged on the screen plate, the mesh of the screen plate became clogged, and the gluing agent could no longer be applied. This indicated that an adhesive agent and a gluing agent, which contained a solvent as a diluent, were not considered to be suitable for preparing a microchip by screen printing.

On the other hand, when a solvent-free acrylic UV curing adhesive agent was used, no clogging of the screen plate mesh occurred even after about 5 hours had passed since the adhesive agent was arranged on the screen plate, and continuous and uniform application of the adhesive agent was possible. By using a UV curing adhesive agent or gluing agent, a curing reaction does not start on a screen plate, but only when a microchip applied with the adhesive agent or the gluing agent is irradiated with UV light of a specific wavelength, thereby improving workability.

Furthermore, when distilled water was fed into a flow path of the prepared microchip, it was observed that distilled water did not leak out of the flow path, but flowed only in a flow path groove.

From these results, it was found that continuous manufacturing of microchips is possible by applying a solvent-free acrylic UV curing adhesive agent to an area other than a flow path of a substrate by screen printing, then bonding the substrate to a film and performing UV irradiation.

### Example 2

### <Microchip Preparation 2>

The optimum film thickness of an adhesive agent to be applied to a microchip was studied. The film thickness of an adhesive agent was controlled by the mesh count of a screen plate, the opening ratio, and the printing speed. A microchip was prepared in the same manner as described in <Microchip Preparation 1> in Example 1, except fora screen plate used for applying an adhesive agent.

The adhesive agent was applied as follows.

Around a flow path of the substrate 201, an adhesive agent UVX-8204 was applied by screen printing. Conditions for application: screen plate with a mesh count of 730, an opening ratio of 39%, and a printing speed of 300 mm/s, resulting in a film thickness of about 3 μm; screen plate with a mesh count of 730, an opening ratio of 39%, and a printing speed of 200 mm/s, resulting in a film thickness of about 5 μm; screen plate with a mesh count of 640, an opening ratio of 39%, and a printing speed of 200 mm/s, resulting in a film thickness of about 10 μm; a mesh count of 400, an opening ratio of 49%, and a printing speed of 300 mm/s, resulting in a film thickness of about 15 μm; and a mesh count of 400, an opening ratio of 49%, and a printing speed of 200 mm/s, resulting in a film thickness of about 18 μm were used.

### <Microchip Evaluation 2>

As a result of preparing a microchip 200 under conditions with a mesh count of 730, an opening ratio of 39%, and a printing speed of 300 mm/s, resulting in a film thickness of 3 μm, a large number of voids were observed around a flow path groove and near the outer circumference of the microchip. This is thought to be due to the fact that the thin film thickness of the adhesive agent made the microchip more susceptible to minute shape abnormalities on the substrate surface.

As a result of preparation of the microchip 200 with a condition of a mesh count of 730, an opening ratio of 39%, and a printing speed of 200 mm/s, resulting in a film thickness of about 5 μm, a condition of a mesh count of 640, an opening ratio of 39%, and a printing speed of 200 mm/s, resulting in a film thickness of about 10 μm, and a condition of a mesh count of 400, an opening ratio of 49%, and a printing speed of 300 mm/s, resulting in a film thickness of about 15 μm, favorable attaching around a flow path groove and near the outer circumference was possible under all conditions.

As a result of preparation of a microchip 200 using a screen plate with a mesh count of 400, an opening ratio of 49%, and a printing speed of 200 mm/s, resulting in a film thickness of about 18 μm, the adhesive agent flowed into a narrowing portion of a flow path 211 due to the thick film thickness of the adhesive agent, making it impossible to feed a liquid into the flow path.

On the other hand, when distilled water was fed into a flow path of a microchip prepared under conditions enabling favorable bonding, the distilled water did not leak out of the flow path, but flowed only in a flow path groove.

Next, the internal pressure strength measurement for the pressure in a flow path was performed on microchips obtained by pasting under a condition of a film thickness of about 10 μm and a condition of a film thickness of about 15 μm. In the internal pressure strength measurement, a minute hole was made in a narrowing portion of the flow path 211 of the microchip 200 from the film side, an epoxy resin was poured into the narrowing portion, cured, and dammed, then distilled water was continuously fed by a pressure pump, and the peak pressure at which the distilled water leaked out of the flow path due to breakdown of the flow path 211 was read by a pressure sensor. As a result of the strength measurements, it was found that for the condition of a film thickness of about 10 μm and for the condition of a film thickness of about 15 μm, the microchips were pressure resistant up to an internal pressure of 526 kPa and 643 kPa, respectively.

From these results, it was found that, although it depends on the microchip's flow path shape and surface condition, applying the adhesive agent and the gluing agent in such a manner that the film thickness was from 5 to 15 μm prevents generation of voids and inflow of the adhesive agent into a flow path groove, enabling pasting of a microchip with favorable liquid feed into the flow path and excellent pressure resistance.

### Example 3

<Microchip Preparation 3>

The optimum viscosity of an adhesive agent to be applied to a microchip was studied. A microchip was prepared in the same way as described in <Microchip Preparation 1> in Example 1, except for the type of an adhesive agent.

For the adhesive agent, SX-UV100A with a viscosity of 35,000 mPa·s, SX-UV100A diluted with ethyl acetate with a viscosity of 31,000 mPa·s, UVX-8204 with a viscosity of 16,000 mPa·s, UVX-8400 with a viscosity of 8,300 mPa·s, U-1455B with a viscosity of 2,000 mPa·s, and NOA60 with a viscosity of 300 mPa·s were used.

A screen plate with a mesh count of 640, an opening ratio of 39%, and a film thickness of about 10 μm was used.

When each adhesive agent was applied to the substrate 201, minute uneven shapes derived from the mesh structure were formed, which gradually smoothed out (leveled) over time. After leveling, the microchip 200 was prepared by attaching the adhesive agent to a film, and the appearance of the microchip 200 was observed.

### <Microchip Evaluation 3>

At a viscosity of 35,000 mPa·s, numerous blurring occurred throughout the microchip, which became voids after attaching together. This is thought to be due to insufficient transfer from the screen plate to the microchip because of the high viscosity of the adhesive agent.

At viscosities of 31,000 mPa·s, 16,000 mPa·s, 8,300 mPa·s, and 2,000 mPa·s, favorable bonding was possible. When distilled water was fed into the flow path of the prepared microchip, it was observed that the distilled water did not leak out of the flow path and flowed only in the flow path groove.

With a viscosity of 300 mPa·s, the adhesive agent flowed into the narrowing portion of the flow path 211 immediately after printing, making it impossible to feed a liquid into the prepared microchip.

From these results, it was found that favorable screen printing is possible when the viscosity of the adhesive agent and the gluing agent is from 2,000 to 31,000 mPa·s.

### Example 4

### <Microchip Preparation 4>

Comparative study of peel strength of chips prepared by applying an adhesive agent or a gluing agent to a microchip was conducted.

A microchip was prepared in the same way as described in <Microchip Preparation 1> in Example 1, except that a gluing agent was used instead of an adhesive agent for attaching together.

A radical reactive acrylic UV curing gluing agent was used for attaching the substrate 201 and the film 202. The viscosity was 9,500 mPa·s. As illustrated in FIG. 3B, a gluing agent was applied to the surface of the substrate 201 with a flow path a solution reservoir in the following method. A UV curing gluing agent was applied to the side on which the flow path and the solution reservoir were provided on the substrate 201 by screen printing. A screen plate with a mesh count of 640, an opening ratio of 39%, and a film thickness of about 10 μm was used.

The substrate 201 on which the gluing agent was applied was dried at 95° C. for 15 minutes to remove the solvent contained in the gluing agent.

The solution reservoir on the gluing agent applied surface of the substrate 201 was layered with the film 202 and irradiated with ultraviolet light of 365 nm wavelength for from 10 to 20 seconds using a UV-LED light source to initiate a curing reaction of the gluing agent and bond the film 202 on the substrate 201 (FIG. 3D).

### <Microchip Evaluation 4>

Observation of the prepared microchip 200 confirmed that no gluing agent flowed into a flow path groove. Furthermore, when distilled water was fed into a flow path, it was observed that the distilled water did not leak out of the flow path, but flowed only in a flow path groove.

From these results, it was found that microchips can be manufactured by applying a UV curing gluing agent to an area of a substrate other than a flow path by screen printing, followed by bonding with a film.

The peel strength between the substrate 201 and the film 202 of the prepared microchip 200 was measured. The peel strength was measured by a 90° peel test using a compact table-top tester EZ-L (Shimadzu Corporation). As a result, the peel strength of a microchip prepared with a UV curing gluing agent was 1.1 N/26.2 mm, while the peel strength of the microchip 200 prepared with a UV curing gluing agent was 3.0 N/26.2 mm. Furthermore, the peel strength of the microchip 200 was 0.7 N/26.2 mm after the bond between the substrate 201 and the film 202 of the microchip 200 was peeled off and the microchip 200 was pressurized and adhered again. As a result of feeding distilled water into a flow path, it was observed that the distilled water did not leak out of the flow path, but flowed only in a flow path groove.

From these results, it was found that the use of a UV curing gluing agent can improve the peel strength of a microchip and that it is possible to re-form a flow path by re-adhesion after peeling.

Although a reaction portion is not provided in this Example, the microchip of the invention can be obtained by providing a reaction portion in the middle of the flow path.

### Example 5

### <Microchip Preparation 5>

A microchip 300 was prepared using an adhesive agent around a flow path in a substrate and a gluing agent near the outer circumference. The microchip was prepared in the same manner as described in <Microchip Preparation 4> of Example 4, except for areas where an adhesive agent and a gluing agent were applied.

The adhesive agent was applied as follows.

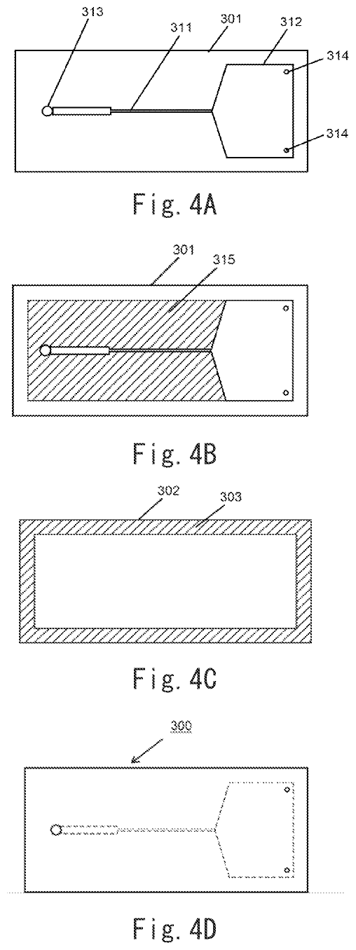

An adhesive agent UVX-8204 was applied to a flow path periphery 315 of the substrate 301 (FIG. 4A) by screen printing. The flow path periphery of a substrate 301 was a 59.4 mm×26.2 mm area located 3 mm inside the short side of a waste liquid reservoir 312 side of the substrate 301, 1 mm inside the short side of a hole serving as an inlet 313, and 3 mm inside the long side on both sides (FIG. 4B). A screen plate with a mesh count of 640, an opening ratio of 39%, and a theoretical film thickness of about 10 μm was used.

A gluing agent was applied as follows.

A gluing agent was applied to an outer circumference portion 303 of a film 302 by a small brush for applying an adhesive agent and a gluing agent. The outer circumference of the film was an area outside the 59.4 mm×26.2 mm rectangle that is 3 mm inside from a short side corresponding to the waste liquid reservoir portion 312 side of the substrate 301 when attached together, 1 mm inside from a short side corresponding to the side of a hole serving as the inlet 313, and 3 mm inside from the long sides of both sides in a 59.4 mm×20.2 mm film 302 of the same dimensions as the substrate 301 (FIG. 4C).

An adhesive agent applied area 315 of the substrate 301 and a gluing agent applied area 303 of the film 302 are attached together without overlapping. Then, using a metal halide light source, ultraviolet light with a continuous distribution of wavelengths from 254 to 450 nm was irradiated for from 10 to 20 seconds to initiate a curing reaction of the adhesive agent and the gluing agent to bond the film 302 on the substrate 301 (FIG. 4D).

### <Microchip Evaluation 5>

The peel strength between the substrate 301 and film 302 of the prepared microchip 300 was measured. As a result, the peel strength of the microchip 300 was 7.0 N/26.2 mm. Furthermore, the bond between the substrate 301 and the film 302 of the microchip 300 was peeled off, and the microchip 300 was pressurized and adhered again, and then, the peel strength of the microchip 300 was 4.3 N/26.2 mm.

From these results, it was found that the peel strength of a microchip can be improved by using an adhesive agent around a flow path of a substrate and a gluing agent near the periphery of the microchip.

By using a UV curing adhesive agent for bonding around a flow path and irradiating the adhesive agent with UV light in a nitrogen-filled environment, inhibition of curing of the adhesive agent by oxygen can be suppressed and the adhesive agent can be completely cured. This is expected to increase the molecular weight of a polymer in the adhesive agent and reduce elution of a low molecular weight substance derived from the adhesive agent into the flow path.

### Example 6

### <Microchip Preparation 6>

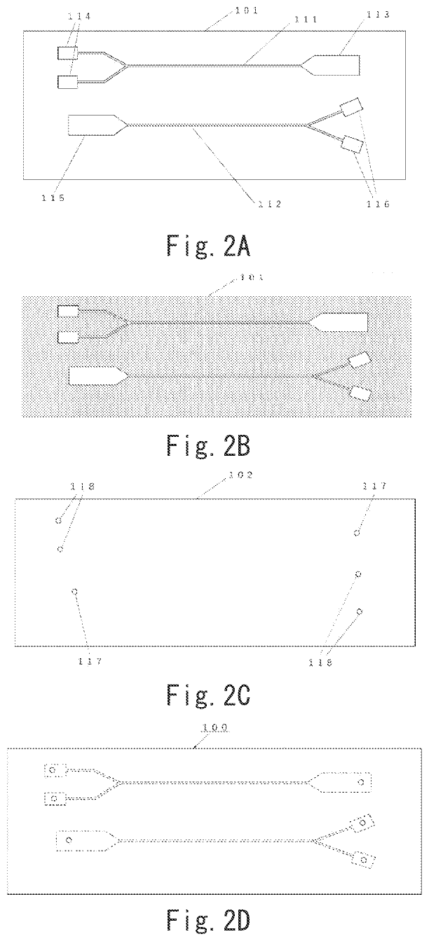

The substrate 101 (Zeon Corporation: COP resin) (size 57×24 mm, thickness 1 mm) illustrated in FIG. 2A was prepared. The substrate 101 included a flow path 111 and a flow path 112 facing each other, and the channel 111 had a structure in which a straight flow path with a length of 19 mm, a depth of 75 μm, and a width of 250 μm was branched into two flow paths with a length of 10 mm, a depth of 75 μm, and a width of 250 μm, and the branched flow path had a bend at a point 5 mm long out of a total length of 10 mm. The ends of the straight and branched flow paths included solution reservoir portions 113 and 114, respectively. In the solution reservoir portion 113 at the end of the straight flow path, the length, depth, and width were 11.5 mm, 100 μm, and 4 mm, respectively. In the solution reservoir portion 114 at the end of the branched flow paths, all were 5 mm in length, 100 μm in depth, and 3 mm in width. The flow path 112 had a structure that branched from a straight flow path with a length of 22 mm, a depth of 75 μm, and a width of 250 μm into two flow paths with a length of 12 mm, a depth of 75 μm, and a width of 250 μm. The end of the straight flow path and the branched flow path included solution reservoir portions 115 and 116, respectively. The solution reservoir portion 115 at the end of the straight flow path was 10 mm in length, 100 μm in depth, and 3 mm in width. The solution reservoir portions 116 at the end of the branched flow path were all 4 mm in length, 100 μm in depth, and 3 mm in width.

For the film 102 of FIG. 2C, a COP film (size 57×24 mm, thickness 100 μm) was used.

Through holes of φ2 mm were made in the film using a Seiken Trepan (kai corporation) in 3×2 locations to align with the solution reservoir portion of the substrate, for a total of 6 locations, and these were used as an inlet 117 and an air hole 118.

An adhesive agent UVX-8204 was used to attach the substrate 101 and the film 102 together. As illustrated in FIG. 2B, the adhesive agent UVX-8204 was applied to the surface of the substrate 101 where a flow path and a solution reservoir portion were provided, by the following method. The adhesive agent UVX-8204 was applied to the surface of the substrate 101 where a flow path and a solution reservoir portion were provided by screen printing. A screen plate used had a mesh count of 730 and an opening ratio of 39%.

The thickness of the adhesive agent applied was about 5 μm.

The film was attached in such a manner that the solution reservoir portion of the substrate 101 on the adhesive agent-applied surface and the through hole of the film overlapped. Then, using a metal halide light source, ultraviolet light with a continuous distribution of wavelengths from 254 to 450 nm was irradiated for from 10 to 20 seconds to initiate a curing reaction of the adhesive agent and bond the film 102 on the substrate 101 (FIG. 2D).

### <Microchip Evaluation 6>

Observation of the prepared microchip 100 confirmed that no adhesive agent flowed into a flow path groove. Furthermore, when distilled water was fed into a flow path, it was observed that the distilled water did not leak out of the flow path, but flowed only in a flow path groove.

From these results, it was found that microchips including flow path grooves having a plurality of shapes can be manufactured by applying a UV curing adhesive agent to an area of a substrate other than a flow path by screen printing, followed by bonding with a film. Although a reaction portion is not provided in this Reference Example, the microchip of the invention can be obtained by providing any number of reaction portions in any area in the middle of the flow path.

### Example 7

### <Microchip Preparation 7>

A substrate 1 (Mitsubishi Chemical Corporation: acrylic resin) (size 3.5×1.5 mm, thickness 3 mm) illustrated in FIG. 1A was prepared. The substrate 1 included a flow path 11 with a length of 7 mm, a depth of about 1 mm, a width of 0.3 mm, and a reaction portion with a circle of 6 mm in diameter and about 1.8 mm in depth.

In the substrate 1, holes serving as an inlet and an outlet were circular through holes with a 2 mm inner diameter and a circular cross section.

A film 2, made of a COP film (size 3.5×1.5 mm, thickness 100 μm), was coated with an S-1570 solution, a hydrophilic reagent, within an area corresponding to a reaction portion of the flow path 11 when layered with the substrate 1.

The concentration of the S-1570 coated and the coating method are as follows.

Within the area corresponding to the reaction portion of the flow path of the substrate 1, 1 μl of a solution of S-1570 with a concentration of 0.1 wt % was applied. The area of application was 12.56 mm² (4 mm in diameter), and the application amount per area was 0.8 μl/mm².

The applied hydrophilic reagent was allowed to dry naturally at room temperature for about 6 hours, and this was used as a hydrophilized film.

Within the hydrophilized area, 12 μl of a PT reagent (Sysmex Corporation) was dropped. The dropped PT reagent solution was spread uniformly over the entire hydrophilized area (4 mm in diameter). The applied PT reagent was then dried at room temperature.

A stirrer (5 mm long, 1 mm diameter) was placed in the reaction portion of the substrate 1 before bonding with an adhesive agent was carried out.

An adhesive agent UVX-8204 was used to attach the substrate 1 to the film 2.

The adhesive agent UVX-8204 was applied on the surface of the substrate 1 with a flow path and a reaction portion by the following method.

On the surface of the substrate 1 with a flow path and a reaction portion, the adhesive agent UVX-8204 was applied by screen printing. The screen plate used had a mesh count of 730 and an opening ratio of 39%, and the thickness of the adhesive agent applied was about 5 μm.

The substrate 1 was attached to the film 2 in such a manner that the reaction portion on the adhesive agent applied surface of the substrate 1 and the PT reagent applied surface of the film 2 overlapped.

Next, using a metal halide light source, the film was bonded onto the substrate 1 by radiation of ultraviolet light with a continuous distribution of wavelengths from 254 to 450 nm for from 10 to 20 seconds, which initiated a curing reaction of the adhesive agent. The obtained microchip was allowed to stand still for 24 hours at room temperature, and then used for a blood coagulation test.

### <Microchip Evaluation 7>

The prepared microchip was used to evaluate blood coagulation time.

50 μl of standard human plasma (SIEMENS) anticoagulated with sodium citrate and unfractionated heparin (Mochida Pharmaceutical Co., Ltd.) added at 1 U/mL was injected through an inlet and filled into a reaction portion. The reaction portion of the microchip was placed on a magnetic stirrer, and the stirrer enclosed in the reaction portion was rotated to achieve a rotation speed of about 100 rpm. This causes the PT reagent coated on the film to mix with a plasma and initiate a coagulation reaction. Formation of a fibrin clot increases the resistance to the stirrer, causing the rotation speed to decrease and stop. The time from the start of rotation to the stop of the stirrer was defined as the coagulation time.

The coagulation time of standard plasma without heparin was 35 seconds, while the coagulation time of plasma containing 1 U/ml heparin was 1 minute and 14 seconds.

From these results, it was found that this microchip can be used to evaluate coagulation using plasma.

### Example 8

### <Microchip Preparation 8>

Preparation of a two-agent containing microchip was performed by separately coating a substrate reaction portion and a film with different reagents. The microchip was prepared in the same manner as described in <Microchip Preparation 2> in Example 1, except for coating of reagents.

Coating of a reagent was performed as follows.

Within a hydrophilized area on a film 2, 3.3 μl of In-tem reagent (Tem Innovations GmbH) activating endogenous blood coagulation was dripped. The In-tem reagent was spread uniformly throughout the subcoated area. This was dried at room temperature.

On the other hand, 3.3 μl of Star-tem reagent (Tem Innovations GmbH) was applied to a reaction portion of the substrate 1 and allowed to dry at room temperature. In the reaction portion of the substrate 1, after the Star-tem reagent (calcium chloride) had dried, a stirrer (5 mm long and 1 mm in diameter) was added.

Next, in the same manner as in Example 1, the adhesive agent UVX-8204 was applied, and the substrate 1 and the film were bonded together by attaching together and curing by ultraviolet light irradiation. The obtained microchip was allowed to stand still at room temperature for 24 hours, and then used for a blood coagulation test.

### <Microchip Evaluation 8>

Into the microchip obtained above, 50 μl of blood containing whole blood of a healthy person collected by a vacuum blood collection tube containing 3.1% sodium citrate (Terumo Corporation) and 0.5 U/ml of unfractionated heparin (Mochida Pharmaceutical) was injected from an inlet, and filled into a reaction portion. The reaction portion of the microchip was placed on a magnetic stirrer, and the stirrer enclosed in the reaction portion was rotated to achieve a rotation speed of about 100 rpm. This causes the in-tem reagent coated on the film, the Star-tem reagent coated on the reaction portion, and the whole blood to mix and initiate a coagulation reaction. As the coagulation reaction progresses, the resistance to the stirrer increases, and the rotation speed decreases and stops. The time from the start to the stop of the stirrer rotation is defined as the coagulation time.

The coagulation time of whole blood from a healthy person without heparin was 2 minutes and 9 seconds, while the coagulation time of whole blood containing 0.5 U/ml of heparin was 7 minutes and 52 seconds.

Although Int-tem and Star-tem reagents are known to aggregate when mixed, it was possible to prepare a two-agent containing microchip capable of analyzing blood coagulation by coating each of the reagents on the reaction area of the film and substrate in such a manner with overlap, and stirring them in the reaction portion during analysis.

### REFERENCE SIGNS LIST

10 Microchip,

1 Substrate,

11 Flow path,

12 Inlet,

13 Outlet,

14 Reaction portion,

2 Film,

21 Reaction substance coated area

100 Microchip,

101 Substrate,

111, 112 Flow path,

113, 114, 115, 116 Solution reservoir,

102 Film,

117 Inlet,

118 Air hole

200 Microchip,

201 Substrate,

211 Flow path,

212 Waste liquid reservoir,

213 Inlet,

214 Air hole,

202 Film

300 Microchip,

301 Substrate,

311 Flow path,

312 Waste liquid reservoir,

313 Inlet,

314 Air hole,

315 Adhesive agent applied portion,

302 Film,

303 Gluing agent applied portion AMENDMENTS TO THE CLAIMS

1. A method for manufacturing a microchip for analyzing a component in a liquid sample by passing the sample through a flow path provided inside and performing a reaction in a reaction portion provided in a portion of the flow path, the method comprising:
providing a substrate comprising on the surface thereof a groove serving as a flow path and a reaction portion in a portion between the both ends of the groove;
applying an adhesive agent or a gluing agent on an area other than the groove on the grooved surface of the substrate;
providing a film on an area of which a reaction substance is applied; and
attaching the film on the substrate in such a manner that the groove on the substrate is covered by the film to form the flow path, and that the reaction portion of the adhesive agent- or the gluing agent-applied surface of the substrate overlaps the area of the film on which the reaction substance is applied.

2. The manufacturing method according to claim 1, wherein the substrate is any one of plastic, silicone, and glass.

3. The manufacturing method according to claim 1, wherein the substrate or the film comprises through holes serving as an inlet and an outlet at positions on both end sides across the reaction portion of a flow path formed by attaching the substrate and the film together.

4. The manufacturing method according to claim 1, wherein the surface of the substrate is hydrophilized, and an adhesive agent or a gluing agent is applied to the hydrophilized surface.

5. The manufacturing method according to claim 1, wherein the adhesive agent or the gluing agent is a UV curing adhesive agent or a UV curing gluing agent.

6. The manufacturing method according to claim 1, wherein the method of applying an adhesive agent or a gluing agent to an area of the substrate other than a groove is screen printing.

7. The manufacturing method according to claim 6, wherein the thickness of an adhesive agent or a gluing agent to be applied by screen printing is 5 to 15 μm.

8. The manufacturing method according to claim 7, wherein the viscosity of an adhesive agent or a gluing agent to be applied by screen printing is 2,000 to 31,000 mPa·s.

9. The manufacturing method according to claim 1, wherein the substrate on whose surface an adhesive agent or a gluing agent is applied is attached to the film after a stirrer is arranged at a position where the reaction portion is to be located.

10. The manufacturing method according to claim 1, wherein the film is cyclo-olefin polymer (COP), cyclo-olefin copolymer (COC), polymethyl methacrylate (PMMA), polystyrene (PS), polycarbonate (PC), or polyethylene terephthalate (PET).

11. The manufacturing method according to claim 1, wherein the thickness of the film is 50 to 200 μm.

12. The manufacturing method according to claim 1, wherein the reaction substance is an antibody, an enzyme, a nucleic acid, a blood coagulation factor, or a bead containing the same.

13. The manufacturing method according to claim 1, wherein the film is hydrophilized in an area to which the reaction substance is applied, and the reaction substance is applied on the hydrophilized area.

14. The manufacturing method according to claim 13, wherein the film is attached to a substrate in which at least a portion of a groove is hydrophilized.

15. The manufacturing method according to claim 1, wherein an adhesive agent is applied to an inner side area of the substrate excluding an outer circumference portion of the substrate and excluding a groove serving as a flow path, a gluing agent is applied to an outer circumference portion of the film, and the substrate and the film are attached with the adhesive agent- or gluing agent-applied side facing inward.
